(19) United States
(12) Patent Application Publication
(10) Pub. No.: US 2017/0278210 A1
(43) Pub. Date: Sep. 28, 2017

(54) METHOD AND SYSTEM FOR PROVIDING HOME CARE SERVICE

(71) Applicant: Ucarer Inc., Taipei City (TW)

(72) Inventors: Hung-Yi CHEN, Taipei City (TW); Shih-Yueh LIN, Taipei City (TW); Shih-Han LIU, Taipei City (TW); Wen-Chun LIAO, Taipei City (TW)

(21) Appl. No.: 15/463,803

(22) Filed: Mar. 20, 2017

(30) Foreign Application Priority Data
Mar. 22, 2016 (TW) 105108749

(51) Int. Cl. G06Q 50/22; G06Q 20/42; H04W 4/02; G06Q 10/06

(52) U.S. Cl. CPC G06Q 50/22; G06Q 10/063112; G06Q 20/42; H04W 4/021; H04M 1/72572

(57) ABSTRACT

A method for providing home care service includes steps of: obtaining profile data including a plurality of available territorial regions that are associated with a number of service providers; receiving a request for the home care service; comparing a required location included in the request with the available territorial regions to determine whether any one of the available territorial regions conforms with the required location; outputting information of a matched service provider who has the available territorial region conforming with the required location; and upon receipt of an order to designate the matched service provider, notifying the matched service provider of an assignment.

### CROSS-REFERENCE TO RELATED APPLICATION

This application claims priority of Taiwanese Patent Application No. 105108749, filed on Mar. 22, 2016.

### FIELD

The disclosure relates to a method and a system for providing various types of home care service.

### BACKGROUND

As the population grows, demand for home care services for the elderly may increase significantly, especially in more remote areas where hospitals and clinics may be scarce. Payment for the home care service to a service provider may be made in cash on an agreed-upon basis, and some controversies may occur when, for example, the service provider is unpaid or underpaid.

### SUMMARY

One object of the disclosure is to provide a method for providing home care service.

According to one embodiment of the disclosure, the method is implemented by a management server and includes steps of:

a) obtaining profile data regarding a number of service providers who provide the home care service, and storing the profile data in a storage device of the management server, the profile data including, for each of the service providers, at least a number of available territorial regions associated with the service provider;

b) receiving a request for the home care service from a client device communicating with the management server, the request including at least a required location for the home care service;

c) comparing the required location with each of the available territorial regions to determine whether any one of the available territorial regions conforms with the required location;

d) when any one of the available territorial regions conforms with the required location, outputting to the client device information of a matched one of the service providers who has the available territorial region conforming with the required location; and

e) upon receipt, from the client device, of an order for the home care service to designate the matched one of the service providers to provide the home care service, transmitting an assignment notification to a provider-end device associated with the matched one of the service providers to notify the matched one of the service providers of an assignment of the home care service.

Another object of the disclosure is to provide a management server that is capable of implementing the above-mentioned method.

According to one embodiment of the disclosure, the management server includes a processing module, a storage device and a communication module. The storage device stores profile data regarding a number of service providers who provide the home care service. The profile data includes, for each of the service providers, at least a number of available territorial regions associated with the service providers. The communicating module is configured to communicate with a client device, and a plurality provider-end devices that are associated with the service providers, respectively.

The processing module is programmed to:
receive a request for the home care service from the client device, the request including at least a required location for the home care service;
compare the required location with each of the available territorial regions to determine whether any one of the available territorial regions conforms with the required location;
when any one of the available territorial regions conforms with the required location, output to the client device information of a matched one of the service providers who has the available territorial region conforming with the required location; and
upon receipt, from the client device, of an order for the home care service to designate the matched one of the service providers to provide the home care service, transmit an assignment notification to one of the provider-end devices that is associated with the matched one of the service providers to notify the matched one of the service providers of an assignment of the home care service.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a system for providing home care service according to one embodiment of the disclosure;

FIG. 2 is a flowchart illustrating steps of a method for providing home care service according to one embodiment of the disclosure;

FIG. 3 illustrates a search interface displayed on a client device;

FIG. 4 is a flowchart illustrating sub-steps for creating an order for the home care service according to one embodiment of the disclosure;

FIG. 5 illustrates an interface displaying information of matched service providers;

FIGS. 6A and 6B illustrate an interface displaying information of a selected service provider being displayed with a button for calculating an estimated charge;

FIGS. 7A and 7B illustrate an interface for asking a user of a client device whether to accept terms and conditions of an agreement;

FIGS. 8A and 8B illustrate an interface for confirming an order for the home care service;

FIGS. 9A to 9C illustrate interfaces displayed on a provider-end device;

FIG. 10 illustrate an interface for asking a service provider whether to accept terms and conditions of an agreement;

FIGS. 11A and 11B illustrate an interface indicating that an assignment has been accepted;

FIG. 12 illustrates an interface for the user of the client device to authorize a payment for the order;

FIGS. 13A to 13D illustrate interfaces displayed on the provider-end device;

FIG. 14 illustrates an interface for the service provider to decline an assignment;

FIGS. 15A and 15B illustrate an interface for the service provider to create an on-duty report; and

FIGS. 16A and 156B illustrate an interface for the service provider to create an off-duty report.

### DETAILED DESCRIPTION

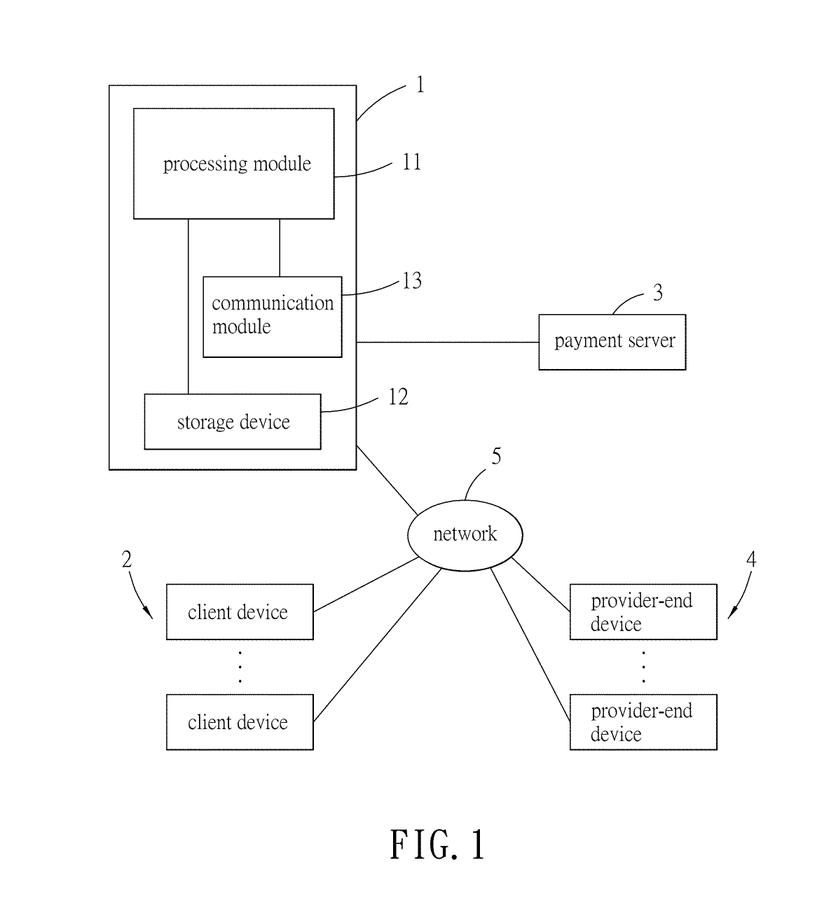

FIG. 1 is a block diagram illustrating a system for providing home care service according to one embodiment of the disclosure. The system includes a management server 1, at least one client device 2, a payment server 3, and at least one provider-end device 4. In this embodiment, a number of client devices 2 and a number of provider-end devices 4 are present. Each of the client devices 2 may be associated with a user potentially having a need for home care service, and each of the provider-end devices 4 may be associated with a service provider who provides the home care service.

In the embodiments of the disclosure, the term “service provider” indicates one or more persons with the relevant certification to provide various types of home care services, and may include professionals such as a professional nurse, a certified nurse aide (CNA), a caregiver, a physiotherapist, an occupational therapist, an dietitian, a masseur, an aromatherapist, a doctor, a pharmacist, a medical laboratory scientist, etc.

The management server 1 includes a processing module 11, a storage device 12 and a communication module 13. The processing module 11 may be embodied using a central processing unit (CPU). The storage device 12 is coupled to the processing module 11, and may be embodied using a non-volatile storage device such as a hard disk (HD), a solid-state drive (SSD), etc. The storage device 12 is to store profile data regarding the service providers. The communication module 13 is coupled to the processing module 11, and is capable of communicating with the client devices 2, the payment server 3, and the provider-end devices 4 via a network 5 (e.g., the Internet).

Each of the client devices 2 may be embodied using an electronic device equipped with network connectivity, such as a personal computer (PC), a laptop, a tablet, a mobile device, a smartphone, etc. Each of the provider-end devices 4 may be embodied using a portable electronic device that includes a positioning device (e.g., a global positioning system (GPS) device).

Each of the service providers has to create a provider profile that includes various entries, for example, a number of available territorial regions associated with the service provider (the available territorial regions being where the service provider can provide the home care service), a charge rate for the home care service, a number of languages that the service provider can use, an age of the service provider, work experience of the service provider, a number of time slots when the service provider is available for providing the home care service, and a number of service types for the home care service that the service provider can provide.

The provider profile may be subsequently transmitted to the management server 1 and stored in the storage device 12 as a part of the profile data. Moreover, the processing module 11 may further append additional information to the provider profile, such as a review score of the service provider that is given by previous customers.

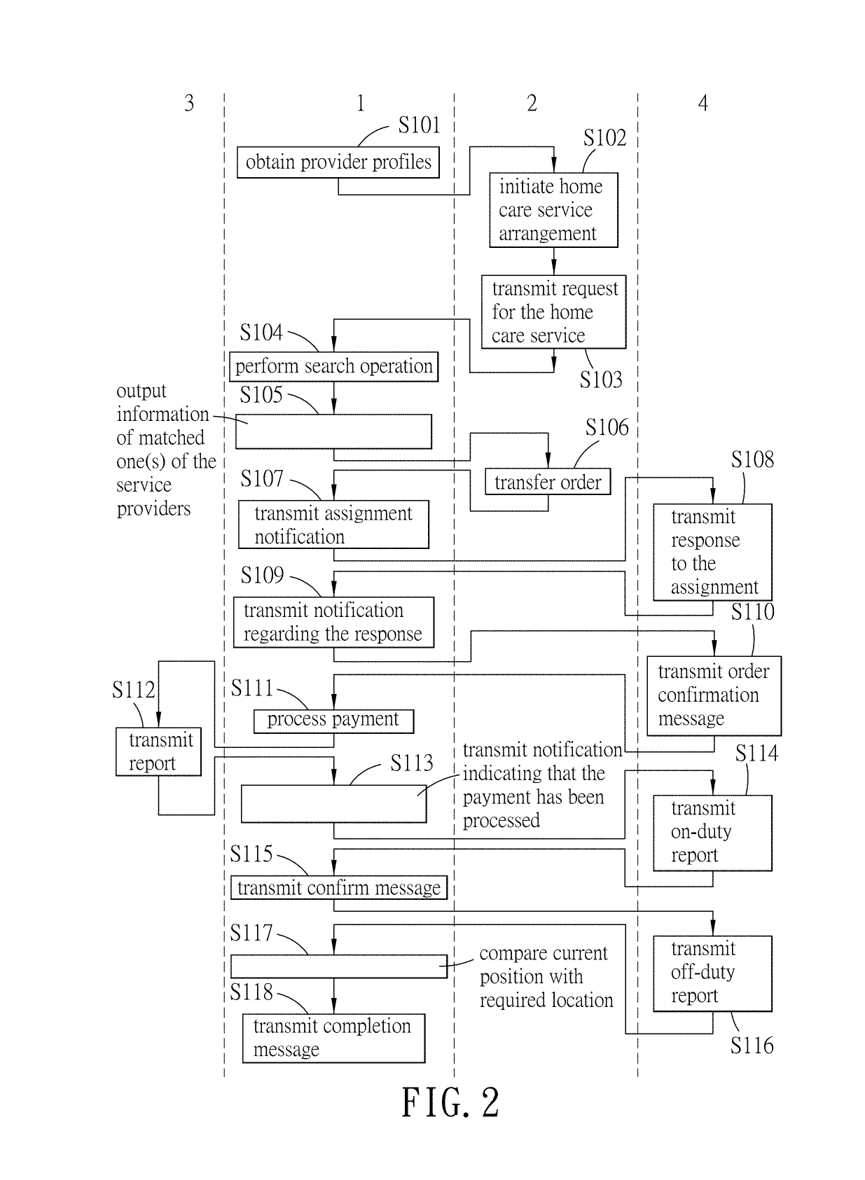

FIG. 2 is a flowchart illustrating steps of a method for providing various types of home care service, according to one embodiment of the disclosure. The method is to be implemented by the management server 1 in communication with the client devices 2, the payment server 3, and the provider-end devices 4. The client devices 2 and the provider-end devices 4 may each be installed with a specific software application that, when executed, is capable of performing relevant operations described in the following steps. In some embodiments, the client devices 2 and the provider-end devices 4 may access a specific website to perform the operations described in the following steps.

In step S101, the management server 1 obtains from the provider-end devices 4 the provider profiles regarding the service providers, respectively, and stores the provider profiles in the storage device 12 as the profile data.

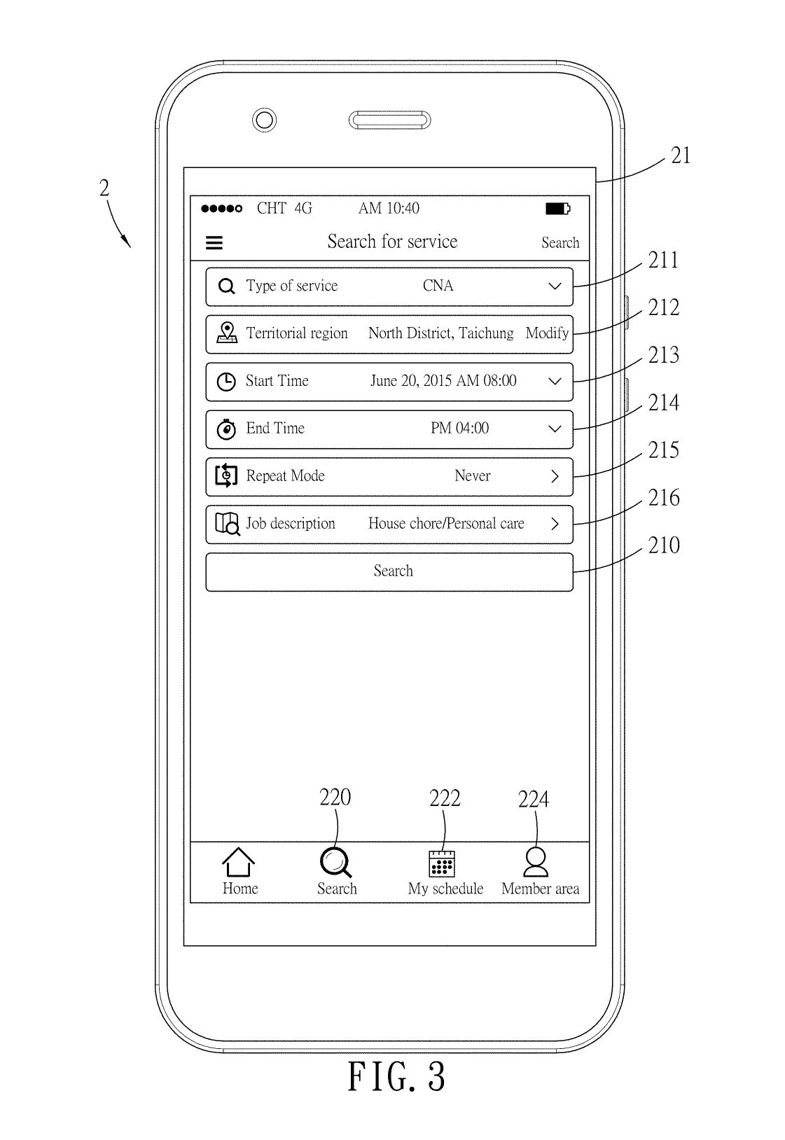

In step S102, the user of one of the client devices 2 may operate the client device 2 to communicate with the management server 1 for initiating home care service arrangement. This may be done by first executing the software application, and then clicking a “search” tab 220 displayed on a bottom part of a display 21 of the client device 2 (see FIG. 3). Since only one of the client devices 2 communicating with the management server 1 for initiating the home care service arrangement is involved in the following steps, only this one of the client devices 2 will be described in the following for the sake of brevity.

In response, the management server 1 transmits interface data to the client device 2. The interface data enables the client device 2 to display a search interface on the display 21 as depicted in FIG. 3.

As shown in FIG. 3, the search interface enables user-input of one or more requirements for the home care service, including a required service type, a required location, a required time slot (including a start time and an end time), a preferable repeat pattern, and one or more required service items. In some embodiments, the search interface may further enable user-input of other requirements for the home care service, such as a required charge rate, a required review score, a required language, a required age and required work experience. It is noted that the required service type may be selected from the various types of service as described above.

In use, the search interface may include a plurality of menus 211 to 216, each associated with one of the requirements listed above. In the example of FIG. 3, the menus 211 to 216 are associated respectively with the required service type, the required location for the home care service, the start time, the end time, the preferable repeat pattern, and the required service items.

In step S103, after the user has inputted at least a part of the search fields and clicks a search button 210 of the search interface, the client device 2 transmits a request for the home care service to the management server 1. The request for the home care service includes the requirements inputted by the user.

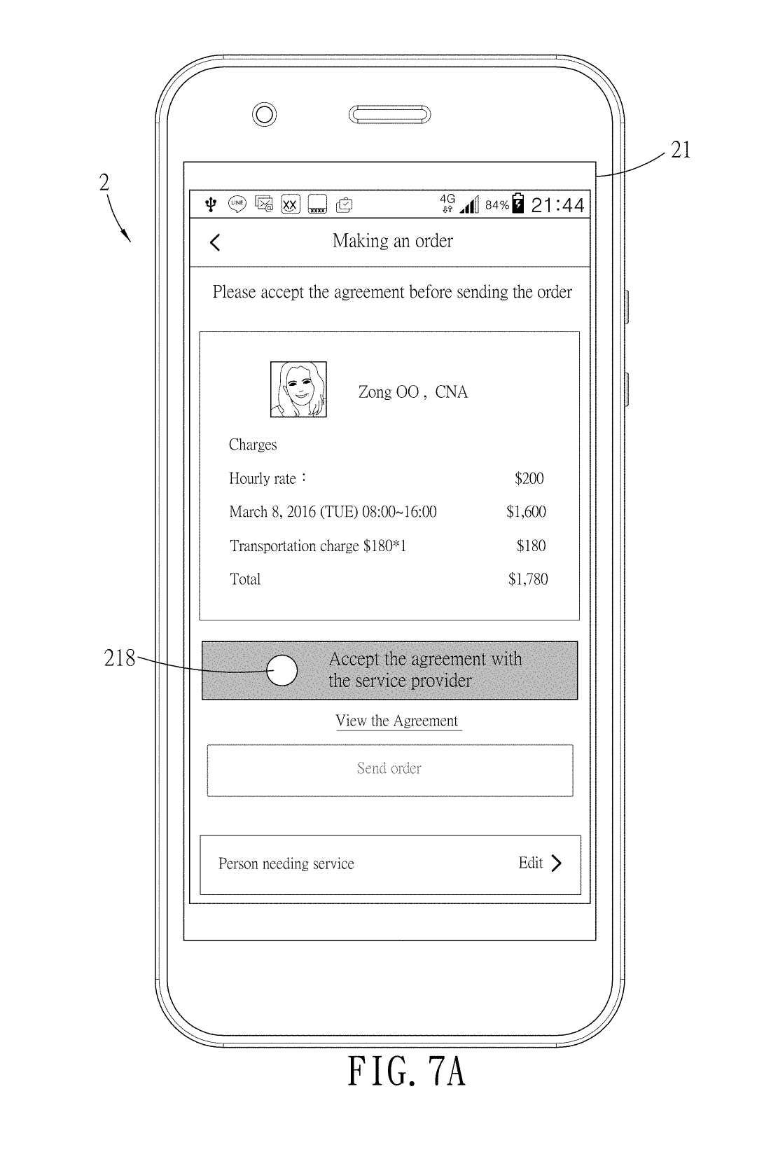

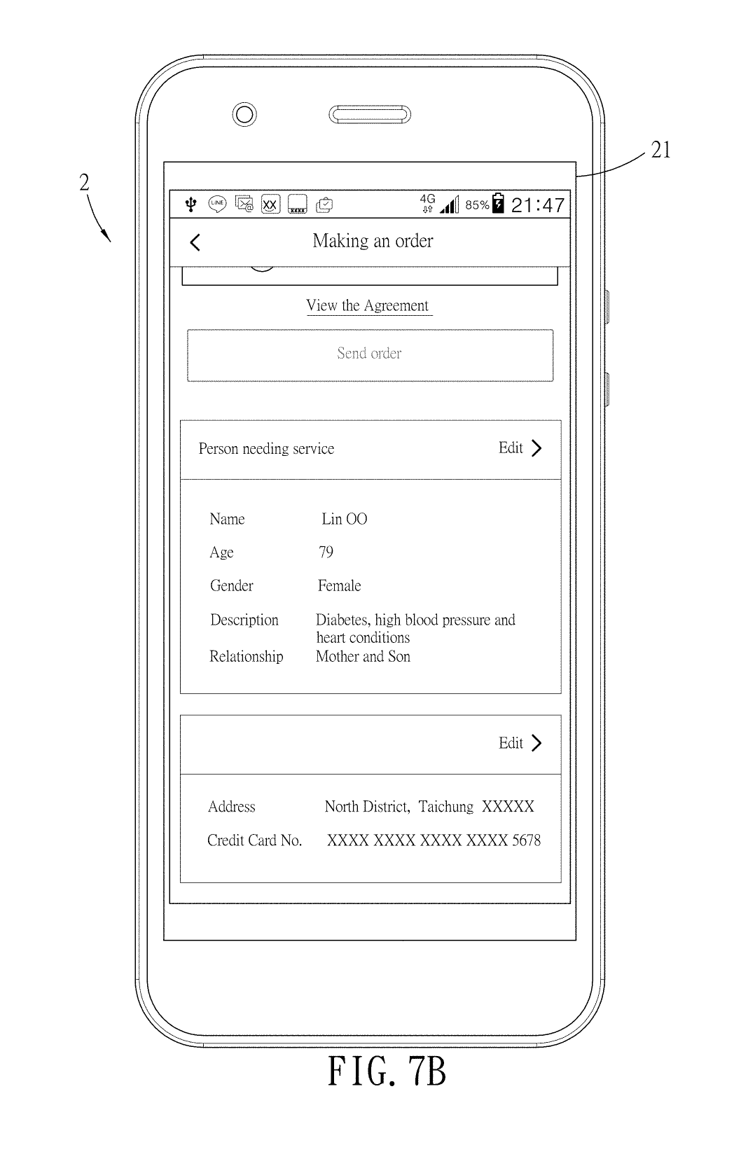

In this embodiment, it may be required for the user to input information regarding a person needing the home care service. Such information may be previously inputted, stored in the storage device 12, and linked to an account of the user of the client device 2. In an example illustrated in FIG. 7B, the person needing the home care service may is 79 year-old female who is the Mother of the user, and has conditions such as diabetes, high blood pressure and heart conditions.

In step S104, the processing module 11 of the management server 1 performs a search operation in order to find the service provider(s) whose provider profile matches the requirements inputted by the user.

For example, when the user only inputs the required location, the processing module 11 compares the required location with each of the available territorial regions to determine whether any one of the available territorial regions conforms with the required location. On the other hand, when various requirements are inputted, the processing module 11 further determines whether any one of the provider profiles conforms with all the requirements.

Then, in step S105, when the search operation yields at least one provider profile that matches the requirement(s) inputted by the user, the processing module 11 determines that the provider profile is associated with a matched one of the service providers, and controls the communication module 13 to output information of the matched one of the service providers to the client device 2, so as to enable the client device 2 to display the information on the display 21.

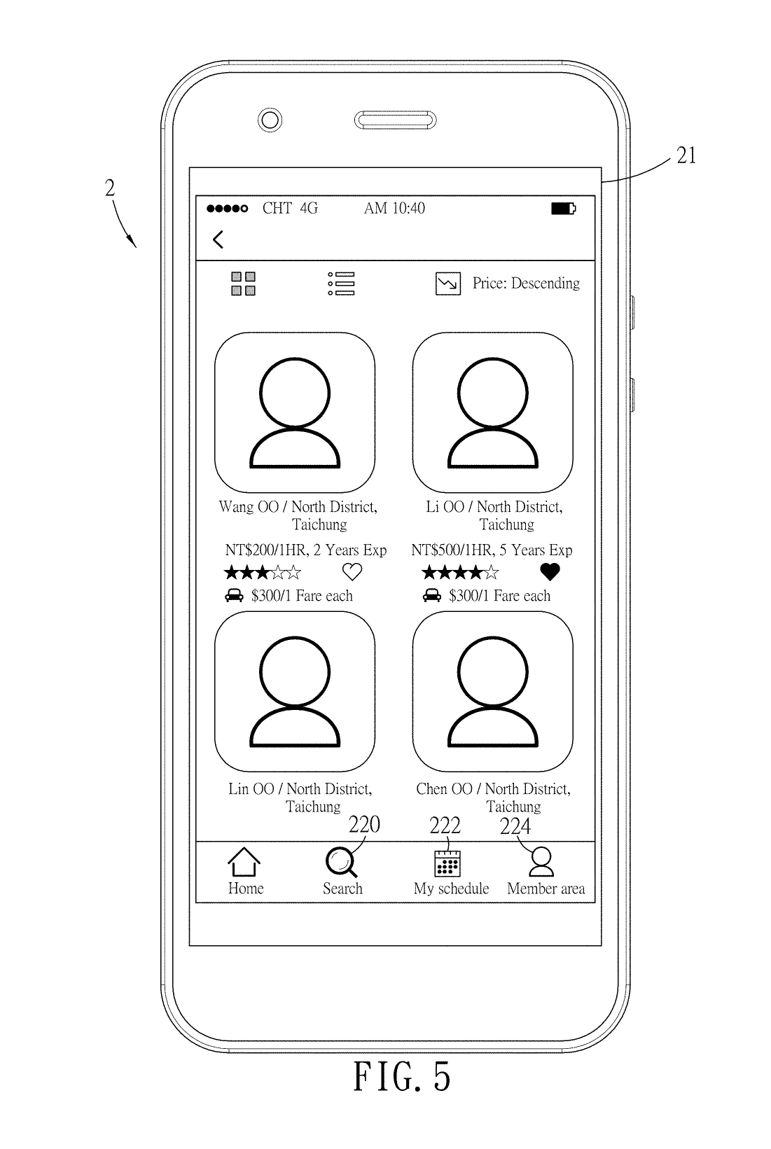

It is noted that multiple service providers may be determined as the matched ones of the service providers and simultaneously have their information transmitted to the client device 2. For example, FIG. 5 shows that the display 21 displays the information of the multiple service providers.

In the example when the user only inputs the required location, the matched one(s) of the service providers has the available territorial region conforming with the required location. In other examples where the user inputs various requirements, the matched one(s) of the service providers has the provider profile(s) conforming with the various requirements.

In step S106, the client device 2 creates an order for the home care service to designate the matched one of the service providers or to designate one of the matched ones of the service providers to provide the home care service, and transfers the order to the management server 1. Since, after the user of the client device 2 designates one of the service providers, only the designated one of the service providers and an associated one of the provider-end device 4 that is associated with the designated service provider are involved in the following steps, only the designated service provider and the associated provider-end device 4 will be described in the following for the sake of brevity.

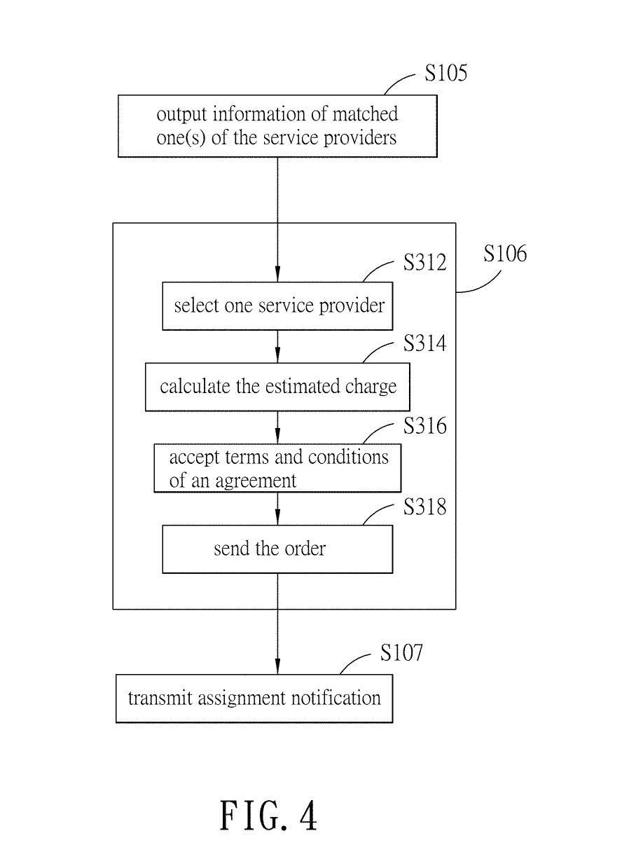

Specifically, FIG. 4 illustrates sub-steps for step S106.

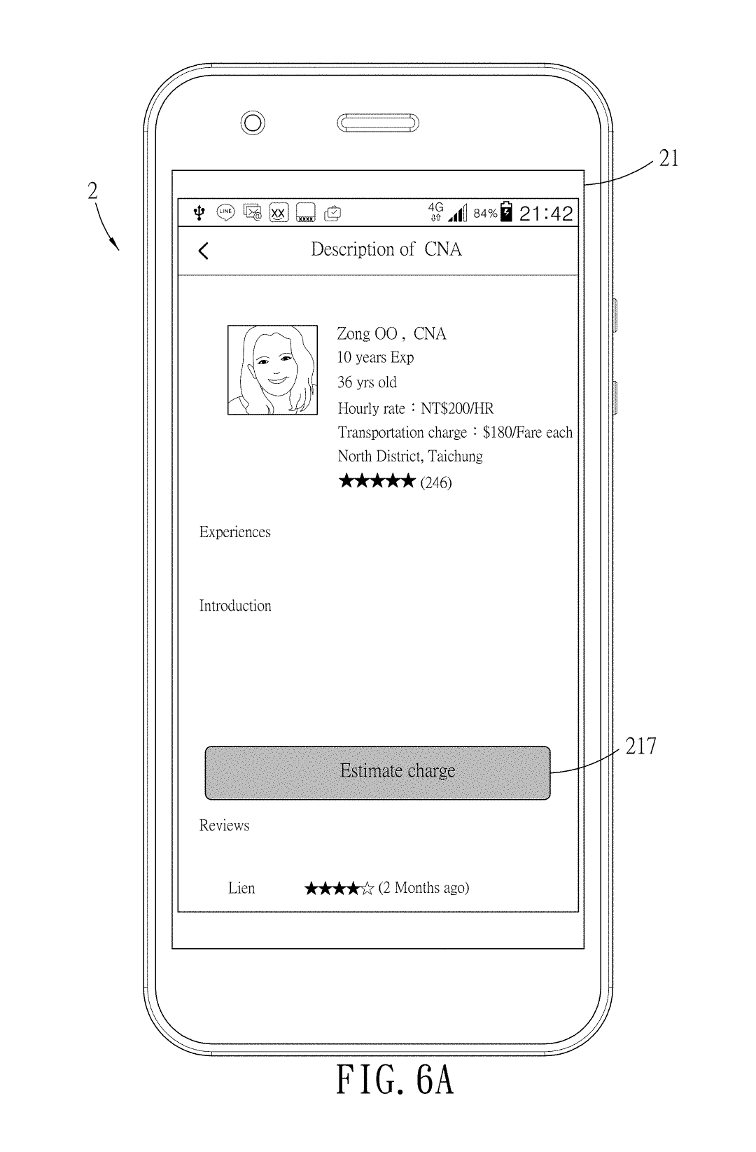

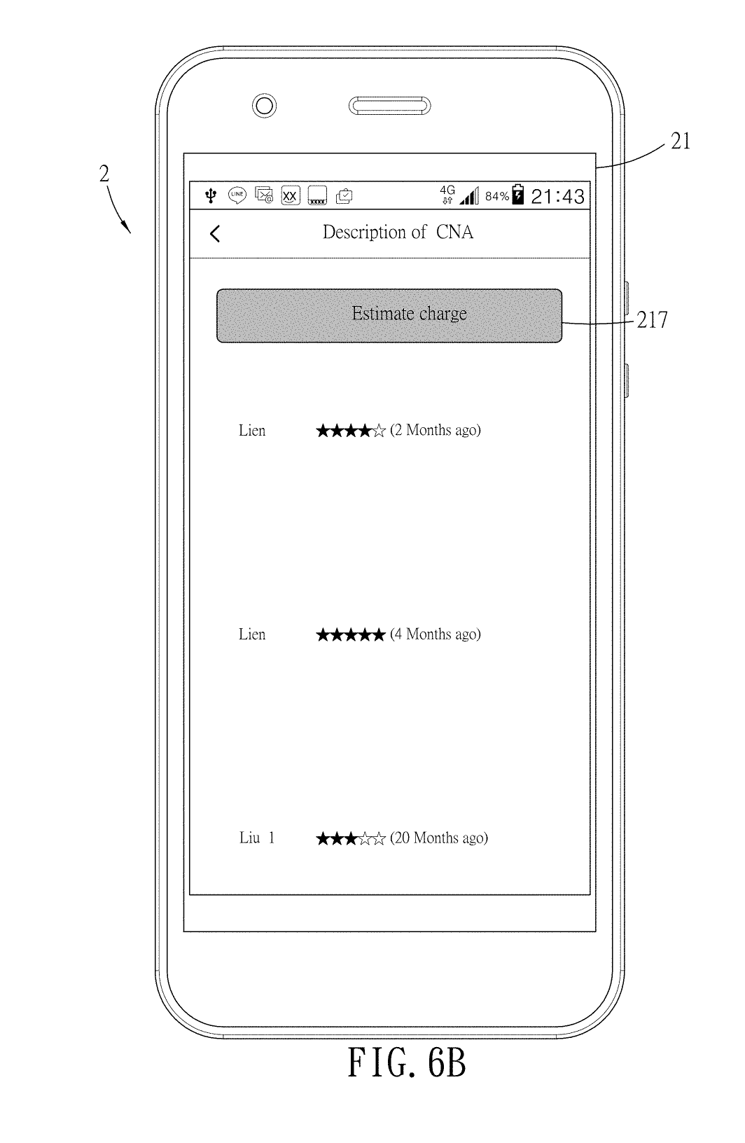

In sub-step S312, the user of the client device 2 may operate the client device 2 to select one of the service providers displayed on the display 21 (see FIG. 6A).

Afterward, in sub-step S314, the user may click a charge estimate button 217 to obtain an estimated charge for the home care service. Additionally, the user may view other information of the selected one of the service providers, such as the review score (see FIG. 6B).

The processing module 11 may calculate the estimated charge based on the charge rate of the selected one of the service providers and a length of the required time slot. In an example illustrated in FIG. 7A, the selected one of the service providers has a charge rate of NTD 200 per hour, the required time slot is eight hours long (i.e., from 08:00 to 16:00), and an estimated transportation charge is NTD 180. As such, the estimated charge thus calculated is NTD 1780.

When the user accepts the estimated charge, the user may click a check field 218 indicating that the user accepts the terms and conditions of an agreement between the service provider and the user of the client device 2 (e.g., a contract therebetween, P2C) as well as an agreement between a party operating the management server 1 and the user (e.g., a contract therebetween, U2P), in sub-step S316. Meanwhile, the user may operate the client device 2 to view the agreement, and to edit the information regarding the person needing the home care service and/or payment information such as a credit card number.

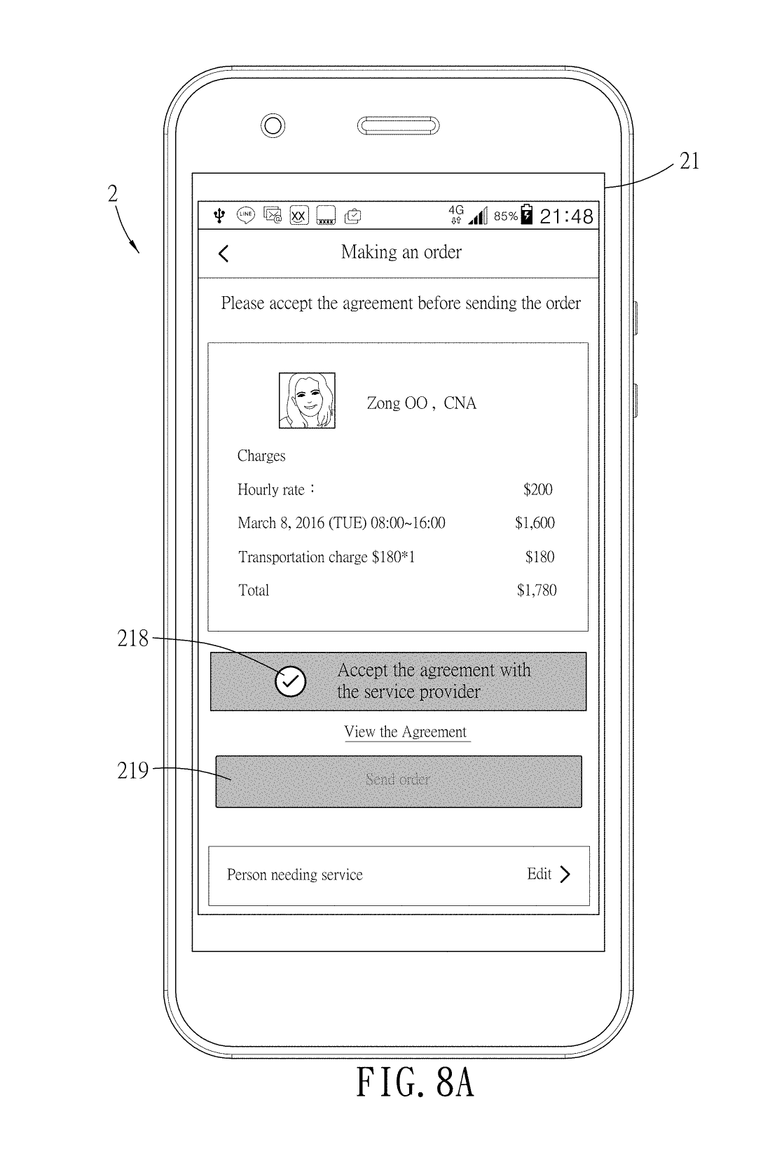

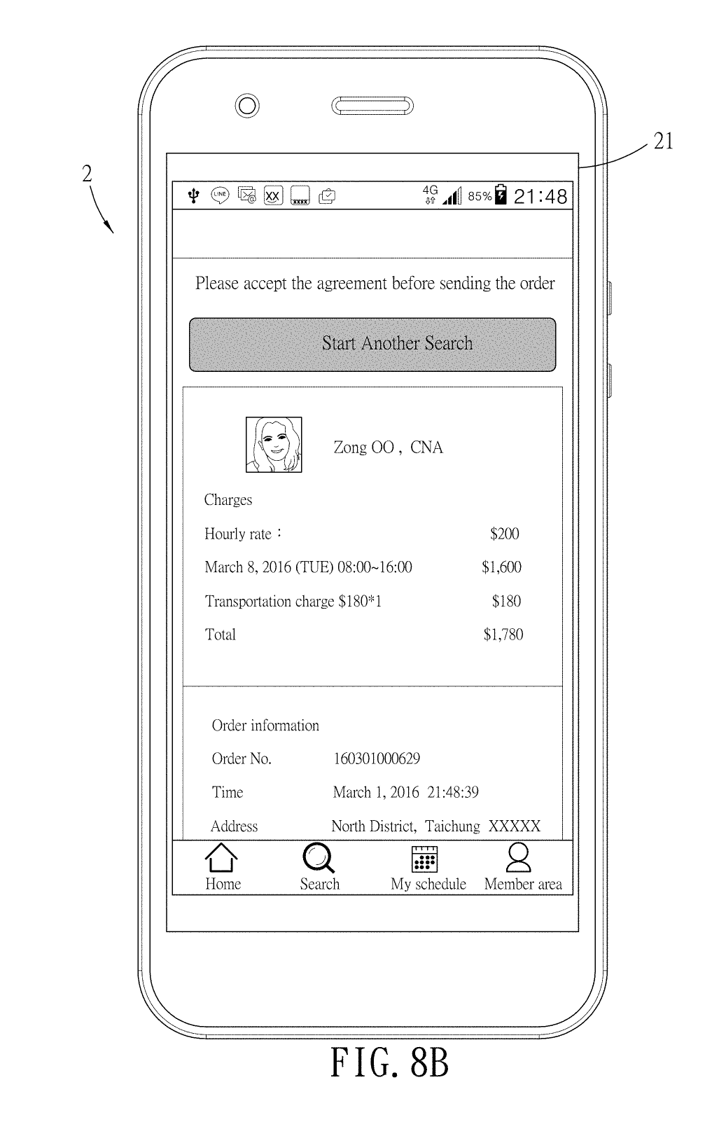

Afterward, in sub-step S318, a “send order” button 219 is enabled when the check field 218 is checked (see FIG. 8A), enabling the user to control the client device 2 to send the order to the management server 1. After the order is sent, the content of the order may be displayed on the display 21 for the user's reference (see FIG. 8B).

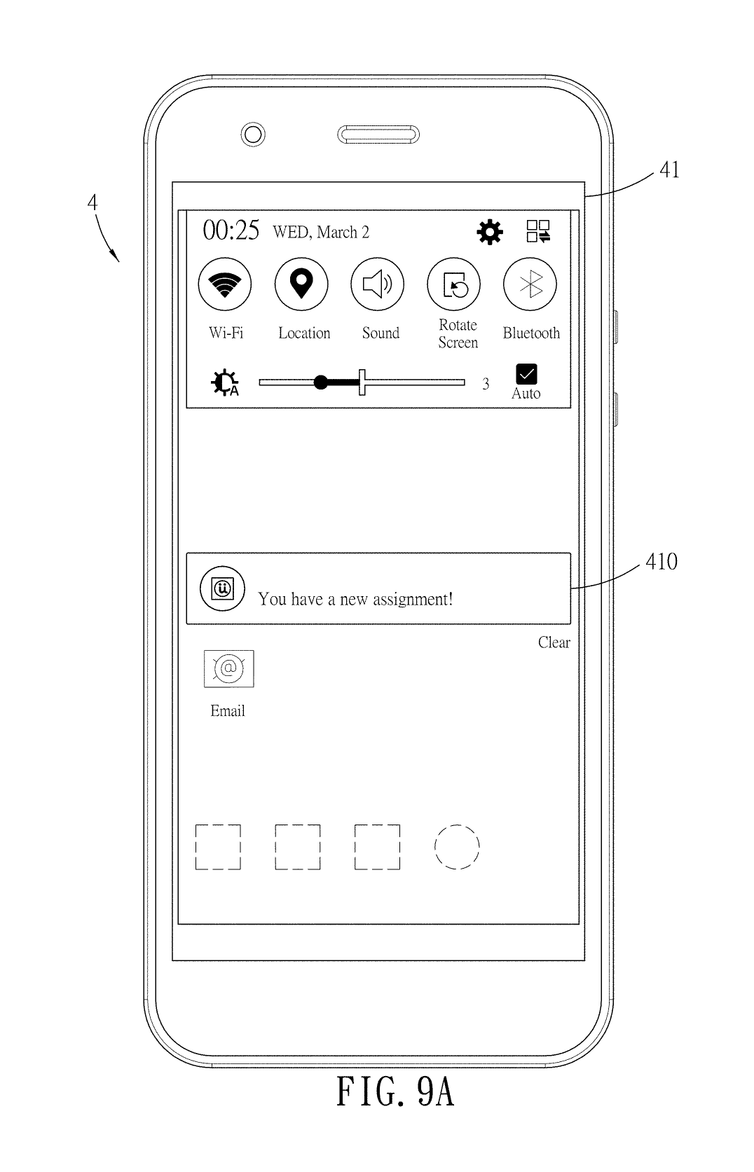

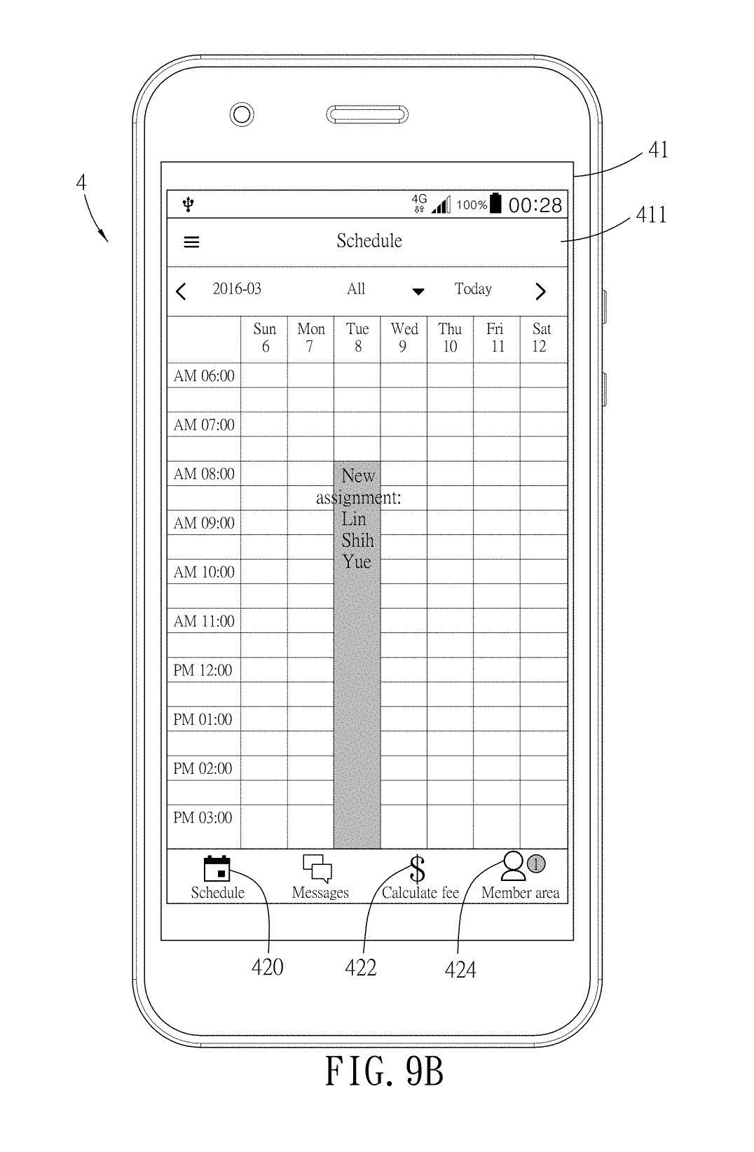

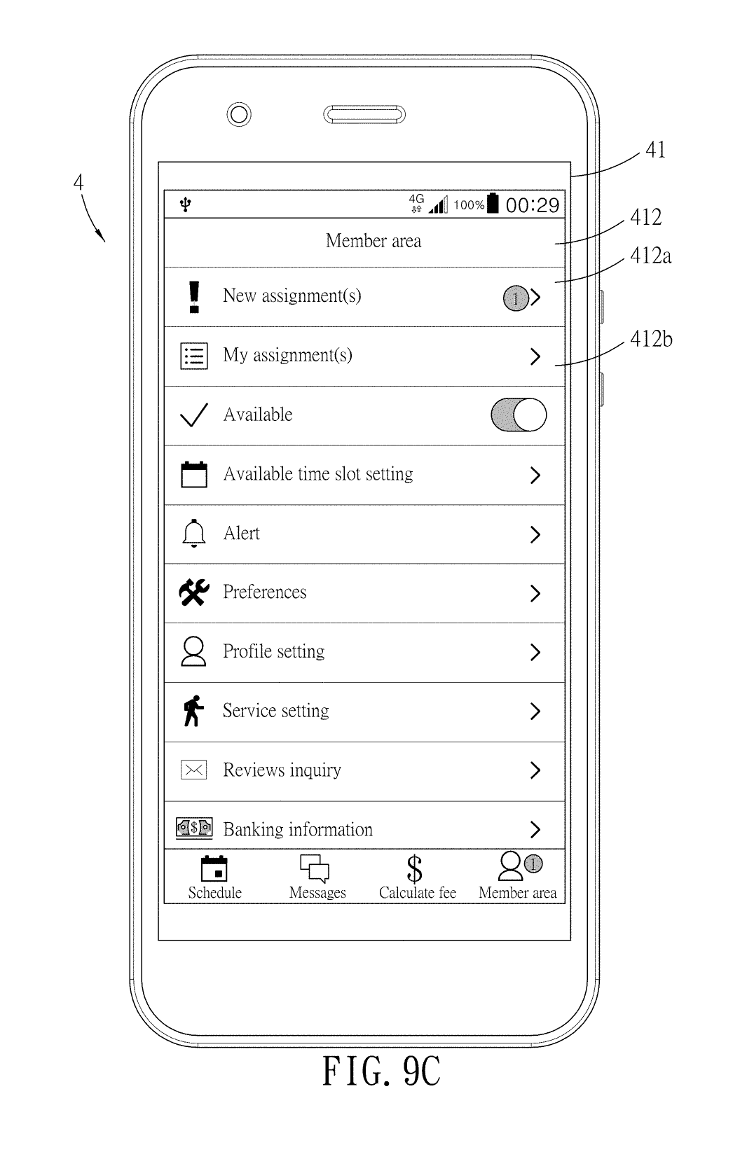

In step S107, upon receipt of the order, the processing module 11 transmits an assignment notification to the provider-end device 4 associated with the service provider, in order to notify the service provider of an assignment of the home care service. The assignment notification may be in the form of a push alert 410 displayed on a display 41 of the provider-end device 4 (see FIG. 9A).

In step S108, the service provider operates the provider-end device 4 to transmit a response to the assignment to the management system 1.

Specifically, when the service provider reacts to the assignment notification (e.g., by clicking on the push alert), the provider-end device 4 displays a schedule 411 on the display 41 of the provider-end device 4, with a particular time slot associated with the assignment being highlighted (see FIG. 9B).

The content of the assignment may be viewed in a member area that will be shown by clicking a tab 424 displayed on a bottom part of the display 41 as shown in FIG. 9B. FIG. 9C illustrates the member area 412 having an assignment section 412a with a circled number indicating that there is one outstanding assignment notification awaiting response, and the service provider is required to confirm whether to accept the assignment of the home care service.

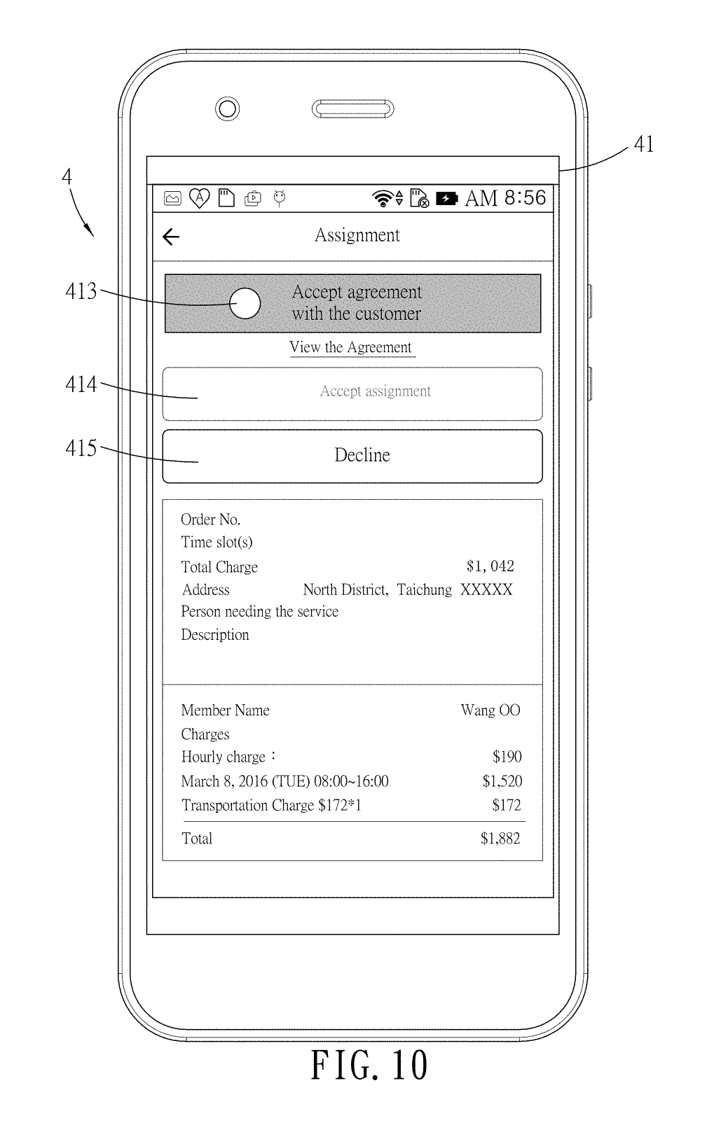

Upon clicking the assignment section 412a, the content of the assignment (s) sent by the client device 2 is displayed (see FIG. 10). When the service provider accepts the terms of the assignment, he/she may click the check field 413 indicating that a standard form of the agreement between the service provider and the user of the client device 2 is accepted.

After the check field 413 is clicked, an accept button 414 is enabled, and the service provider may click the accept button 414 to control the provider-end device 4 to send the response to the management server 1 accordingly. Alternatively, the service provider may click a decline button 415 irrespective of the check field 413, and subsequently control the provider-end device 4 to send the response to the management server 1 accordingly.

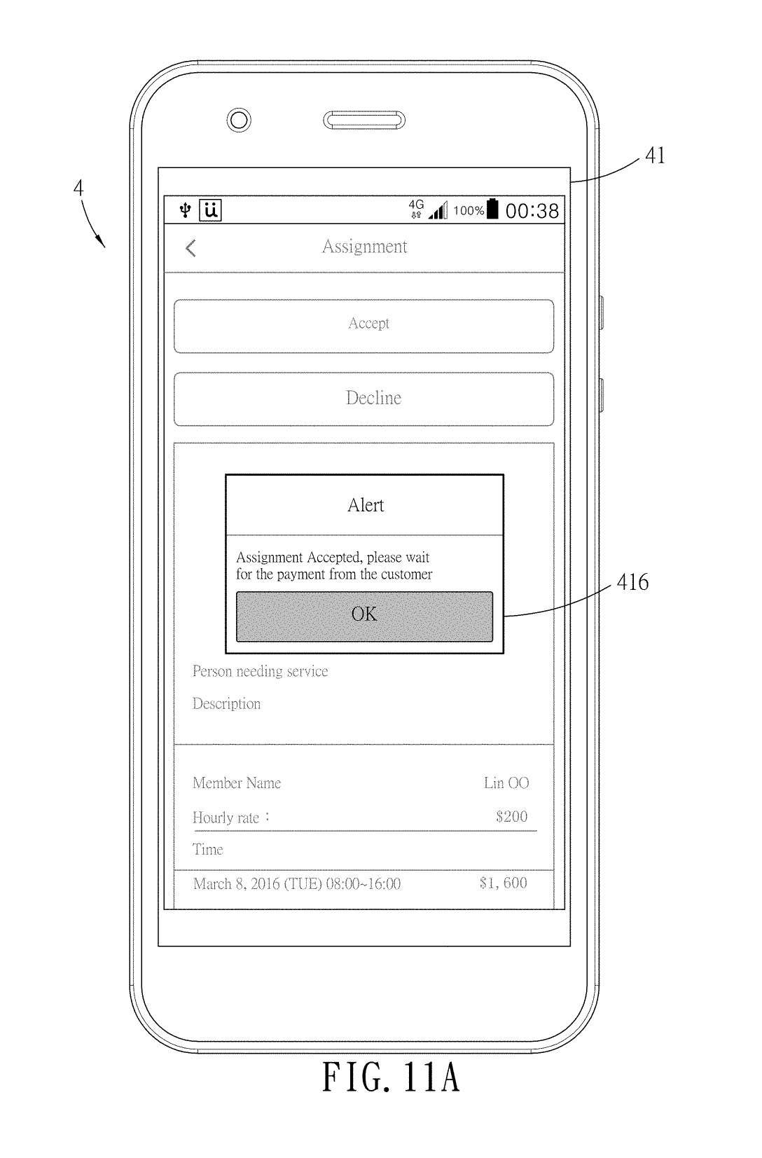

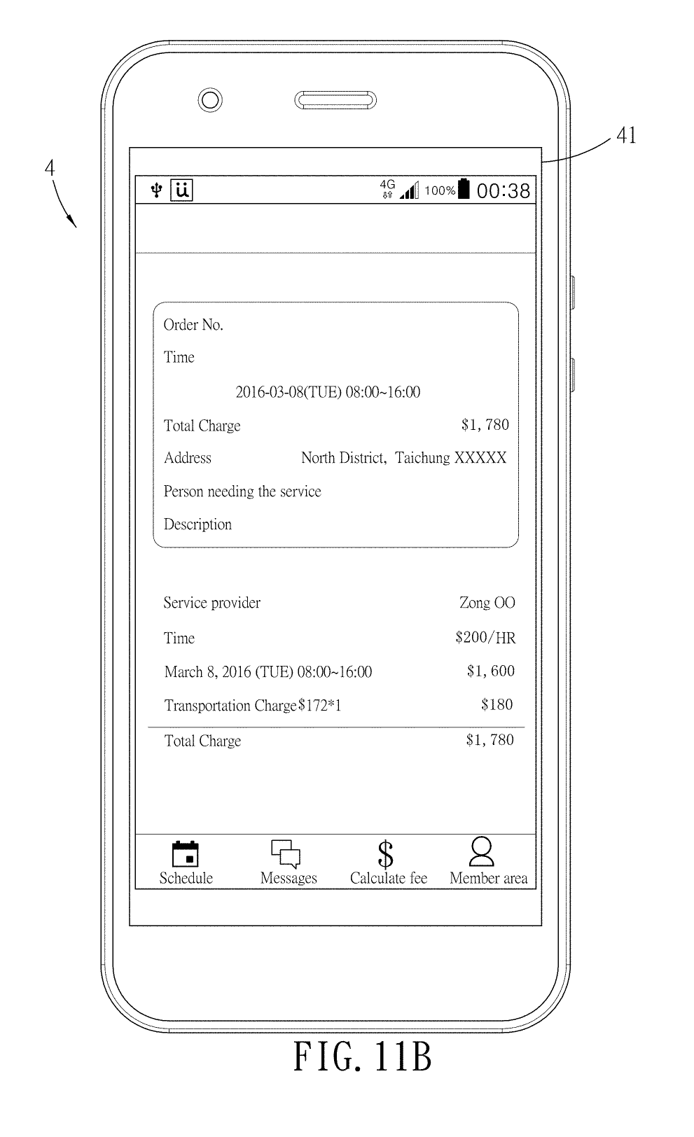

FIG. 11A illustrates a notification 416 displayed on the display 41 indicating that the response is sent. Specifically, in this example, the notification 416 indicates that the assignment has been accepted. FIG. 11B illustrates content of the assignment being displayed by the display 41 for reference.

In step S109, upon receipt of the response from the provider-end device 4, the processing module 11 transmits a notification to the client device 2 regarding the response of the service provider.

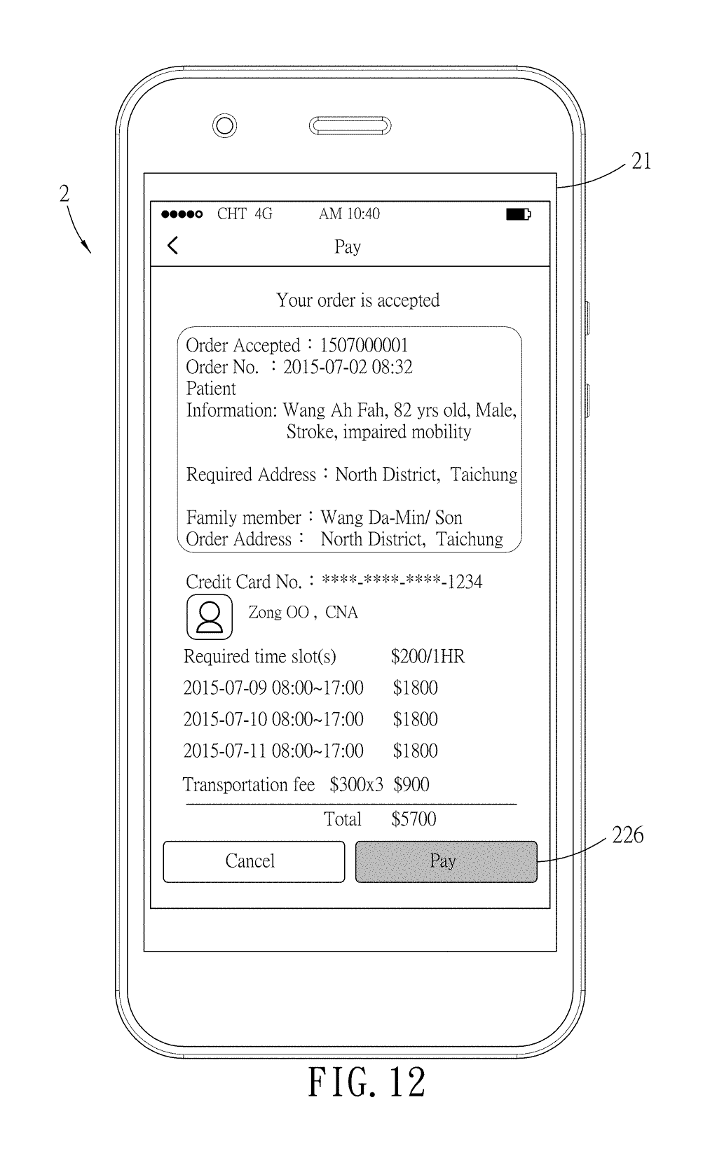

Specifically, when the response includes an assignment confirmation message indicating that the service provider has accepted the assignment, the processing module 11 transmits an order notification to the client device 2 to notify the user of the client device 2 that the service provider has accepted the assignment and to require the user to confirm a payment for the order of the home care service. FIG. 12 illustrates an interface showing the order notification displayed on the display 21 and including a payment button 219. The user can click the payment button 219 to authorize the payment for the order.

When the payment button 219 is clicked, in step S110, the client device 2 transmits an order confirmation message to the management server 1. In response, in step S111, the processing module 11 communicates with the payment server 3 for processing the payment. The processing of the payment may be implemented using the following manner.

In one embodiment of the disclosure, the payment server 3 may be in association with a number of electronic payment institutions. After the user authorizes the payment for the order, one of the electronic payment institutions may be selected to collect the payment from the user (e.g., via a bank account, a credit card, etc.) and proceed to transfer the payment to an account associated with the management server 1. The selection of the electronic payment institutions may be based on a transaction limit imposed on each of the electronic payment institutions. For example, when it is determined that an amount of transaction conducted via a specific one of the electronic payment institutions has reached a threshold ratio of the corresponding transaction limit, the payment server 3 may avoid selecting the specific one of the electronic payment institutions for subsequent payments.

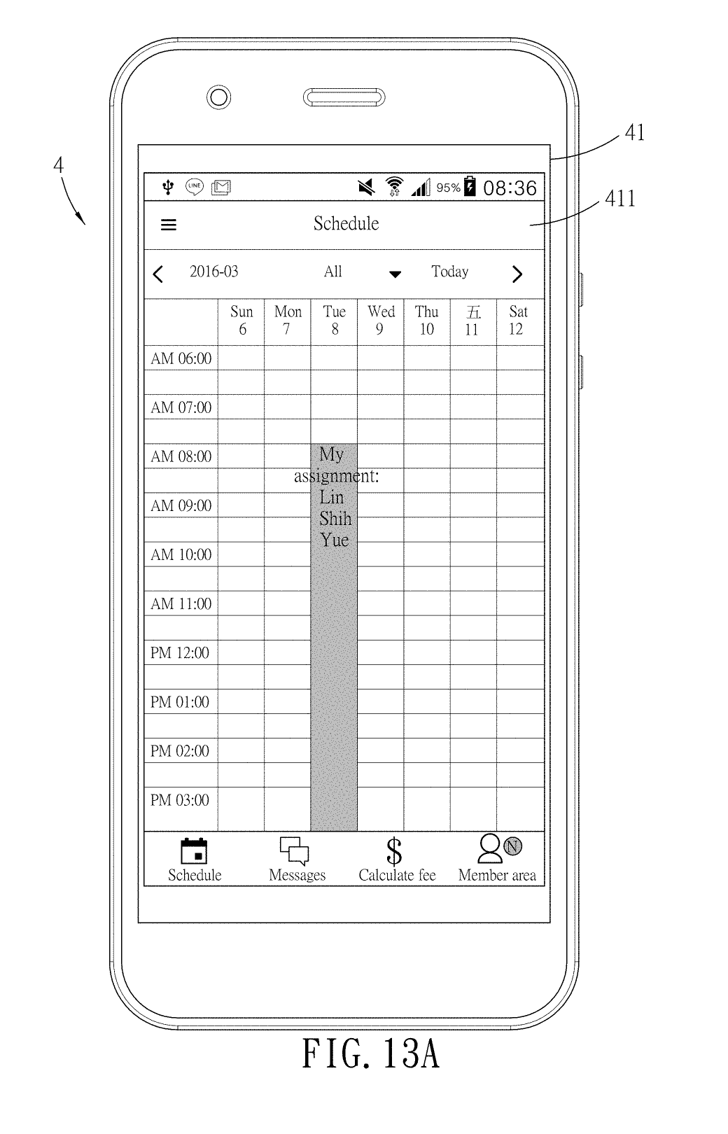

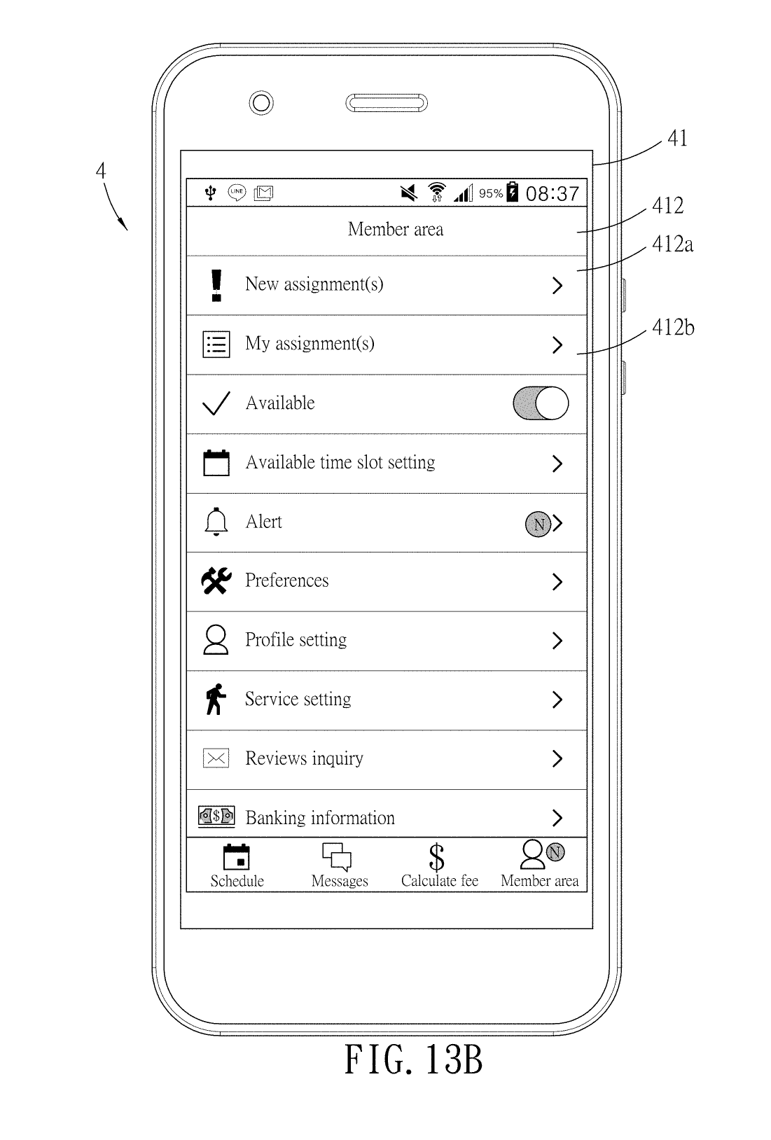

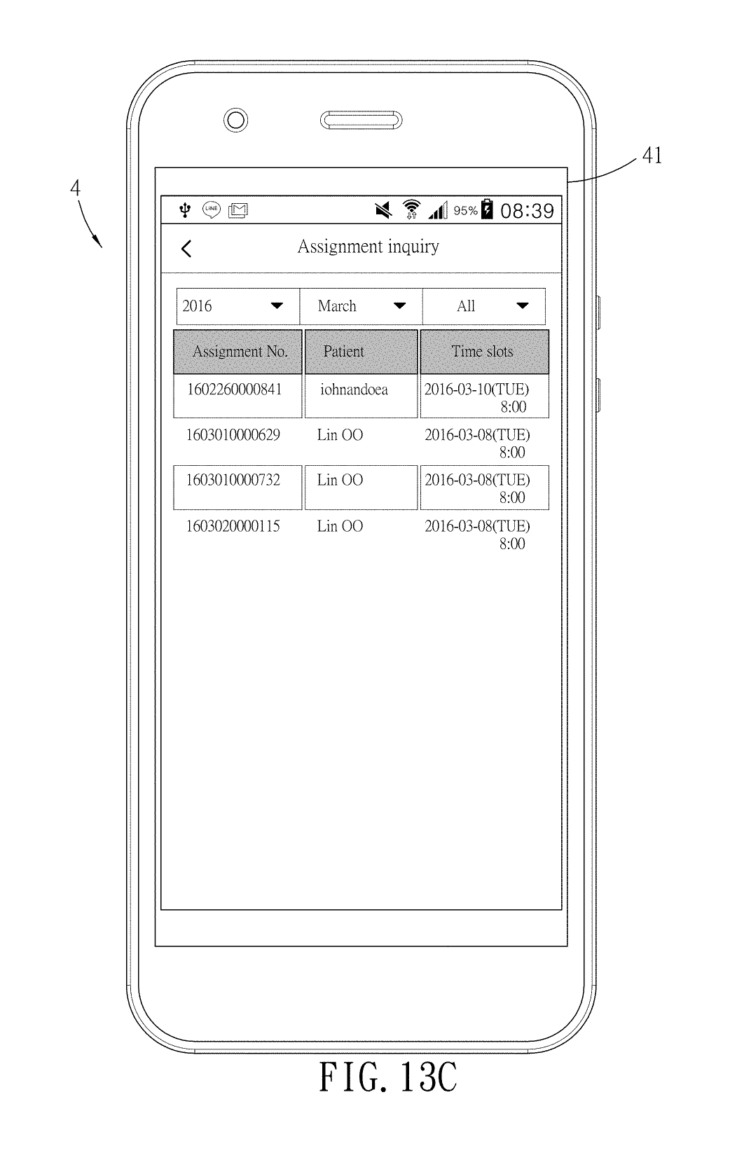

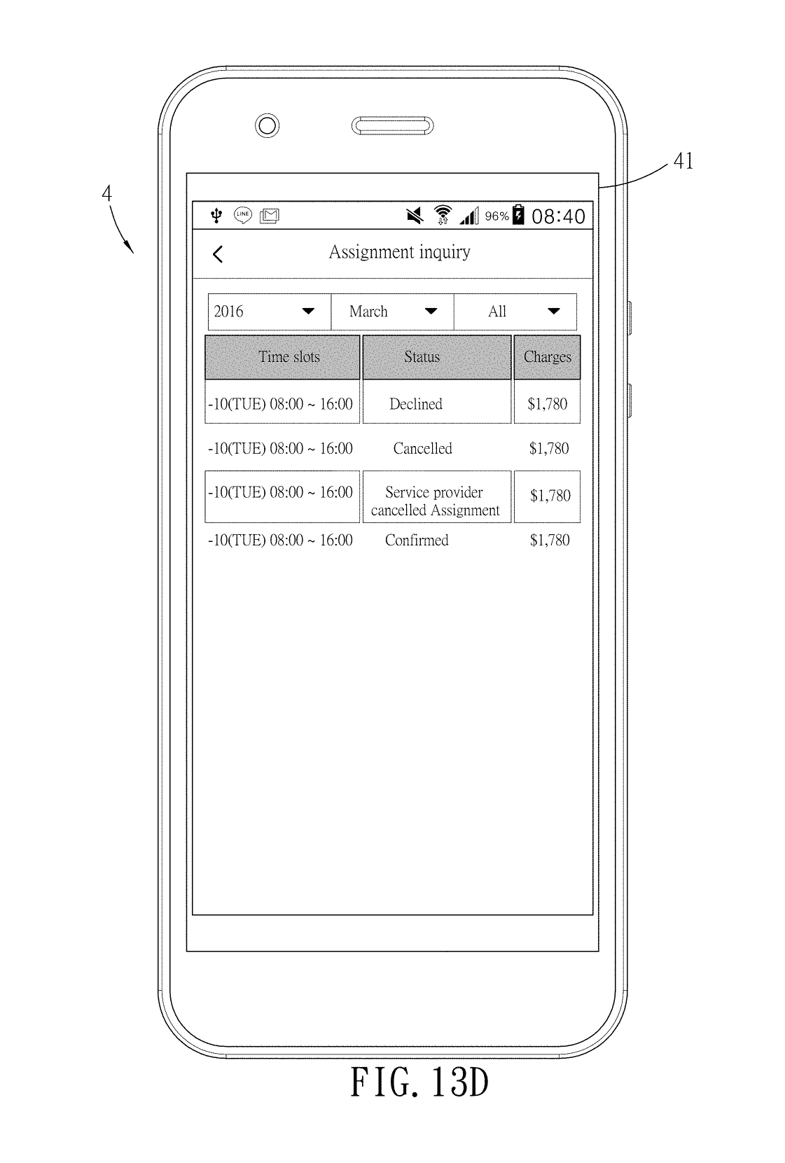

After the payment is successfully processed, in step S112, the payment server 3 transmits a report to the management server 1. In turn, in step S113, the processing module 11 transmits a notification to the provider-end device 4 indicating that the payment has been processed. At this stage, the particular time slot associated with the assignment in the schedule 411 now indicates that the assignment has been confirmed (see FIG. 13A).

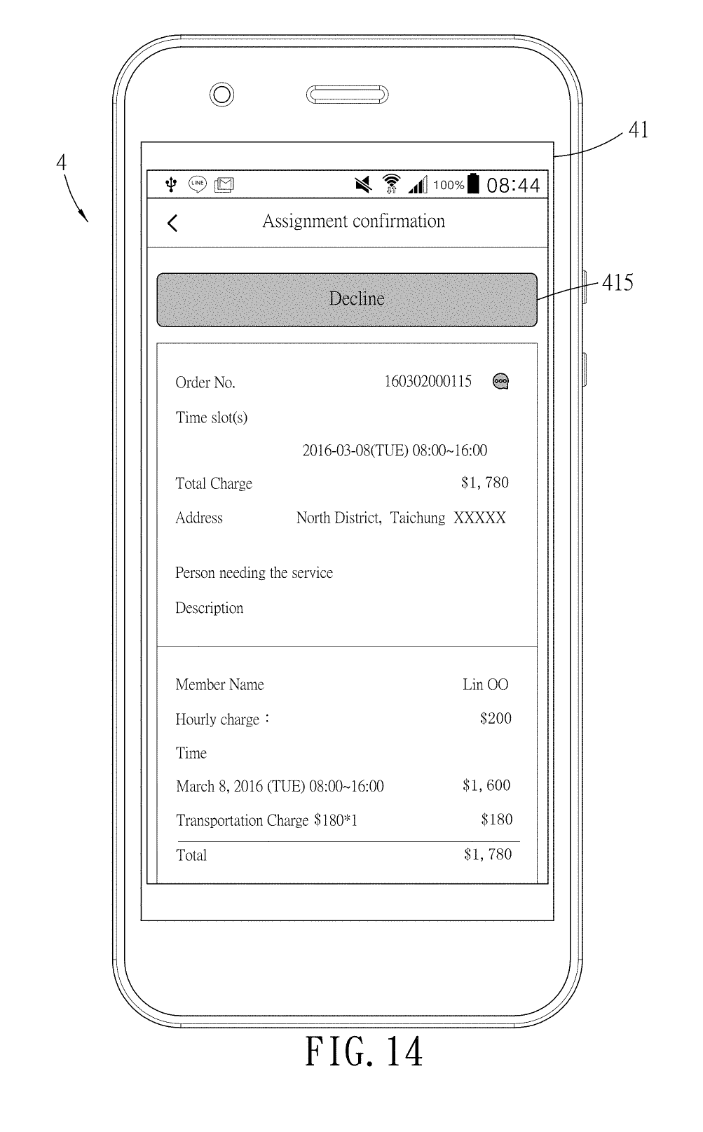

In one embodiment, all assignments associated with the service provider may be checked in an assignment section 412b under the member area 412 (see FIG. 13B). FIGS. 13C and 13D illustrate content of exemplary assignments associated with the service provider. Upon clicking on one of the assignments, the service provider is able to examine the content and/or declining the assignment by clicking a decline button 415 (see FIG. 14).

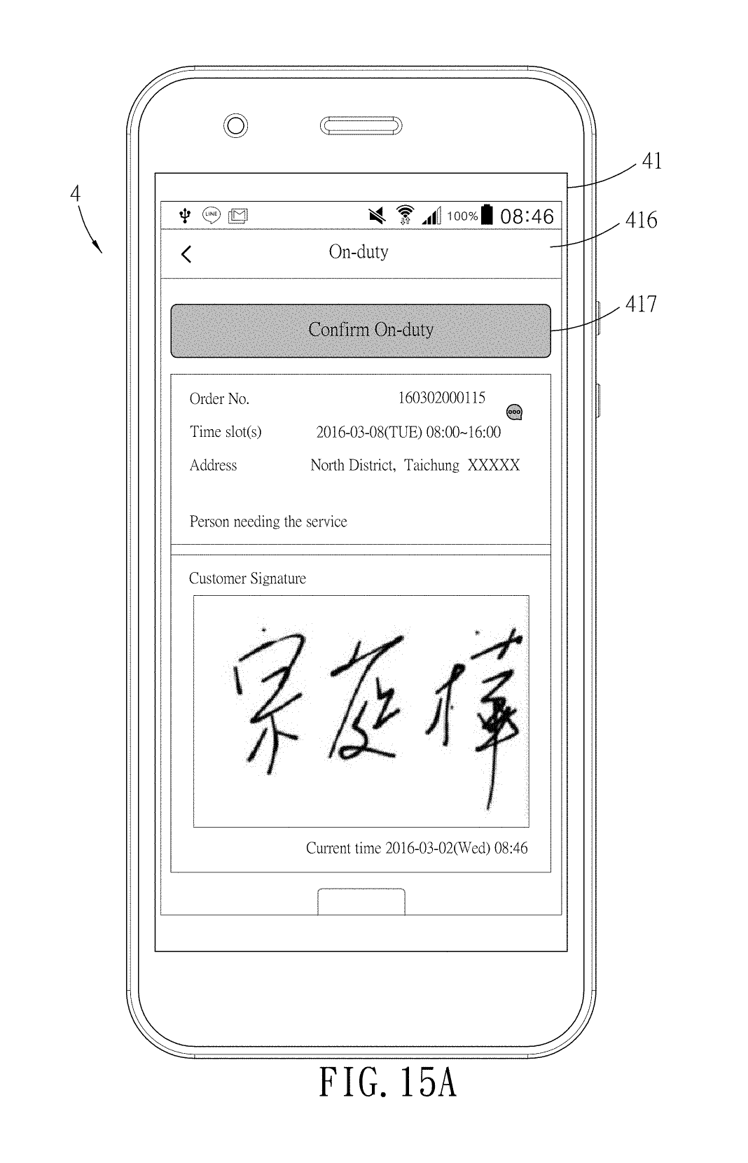

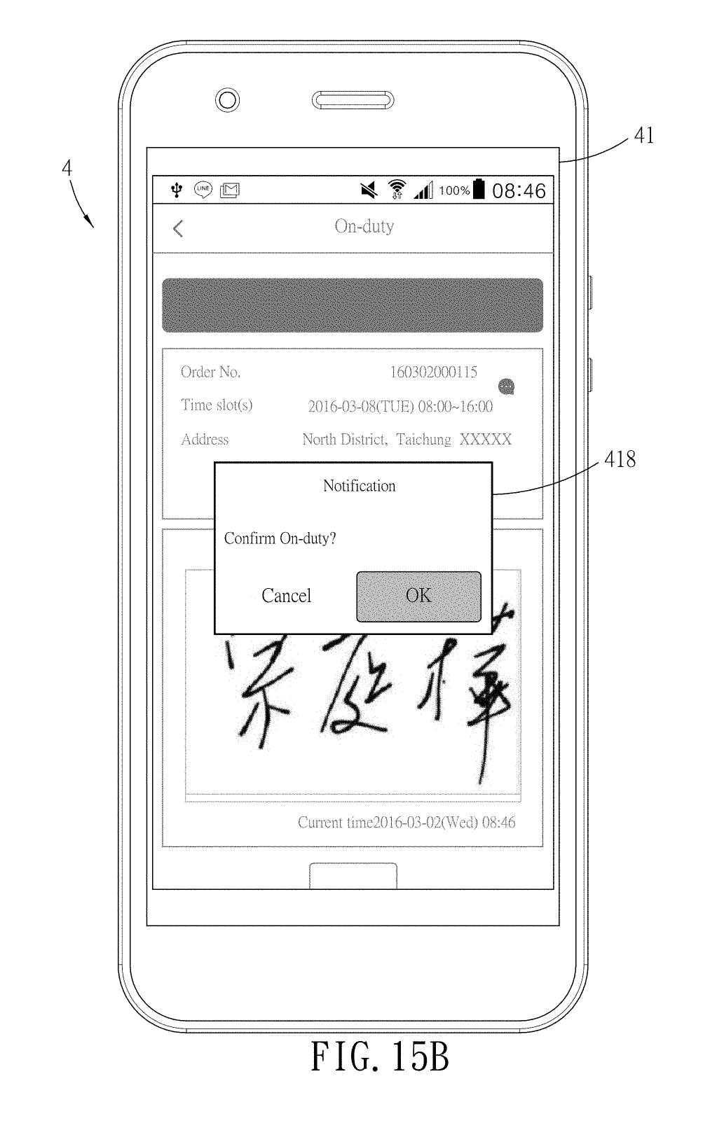

Afterward, the service provider proceeds to the required location at the required start time in order to start the home care service. Then, the user of the client device 2 may provide a signature on the provider-end device 4 on an on-duty screen 416 (see FIG. 15A) and clicking an on-duty button 417 on the on-duty screen 416, and accordingly, the provider-end device 4 transmits an on-duty report, including the signature of the user of the client device 2, to the management server 1 in step S114. In one embodiment, the on-duty report further includes position information of a current position of the provider-end device 4 generated by the positioning device, and a time stamp. In some embodiments, a further confirmation may be required by the provider-end device 4 (see FIG. 15B) before transmission of the on-duty report.

In step S115, the management server 1 transmits a confirm message to the provider-end device 4 in response to receipt of the on-duty report.

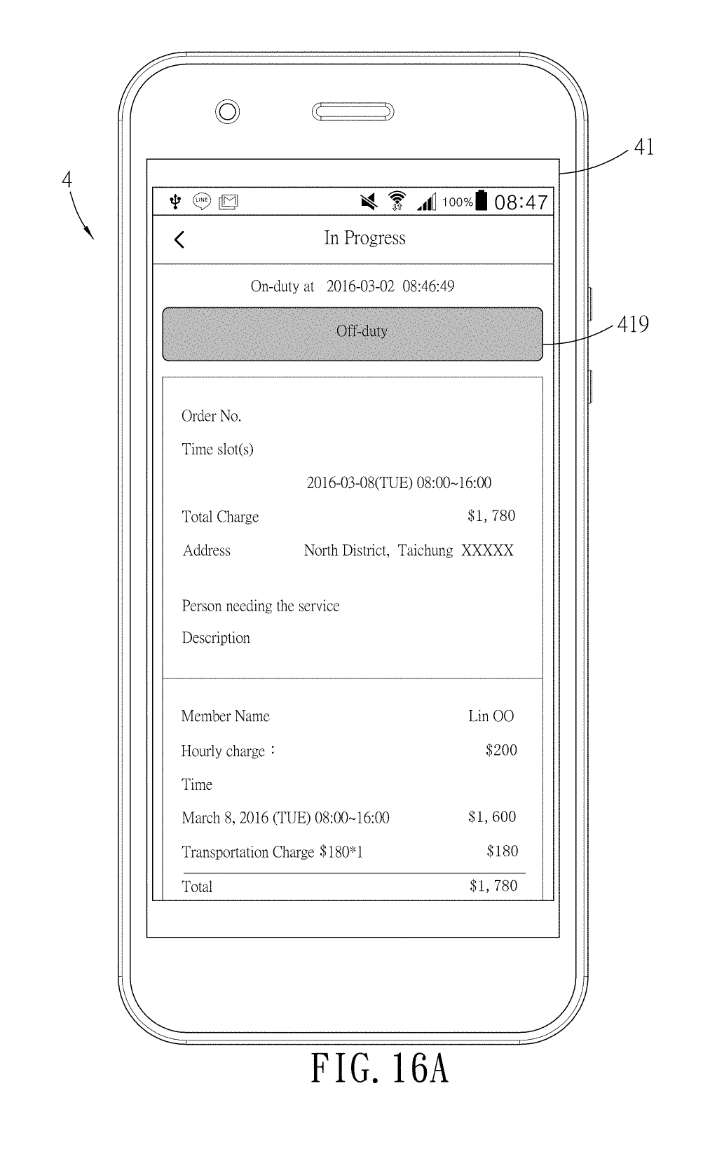

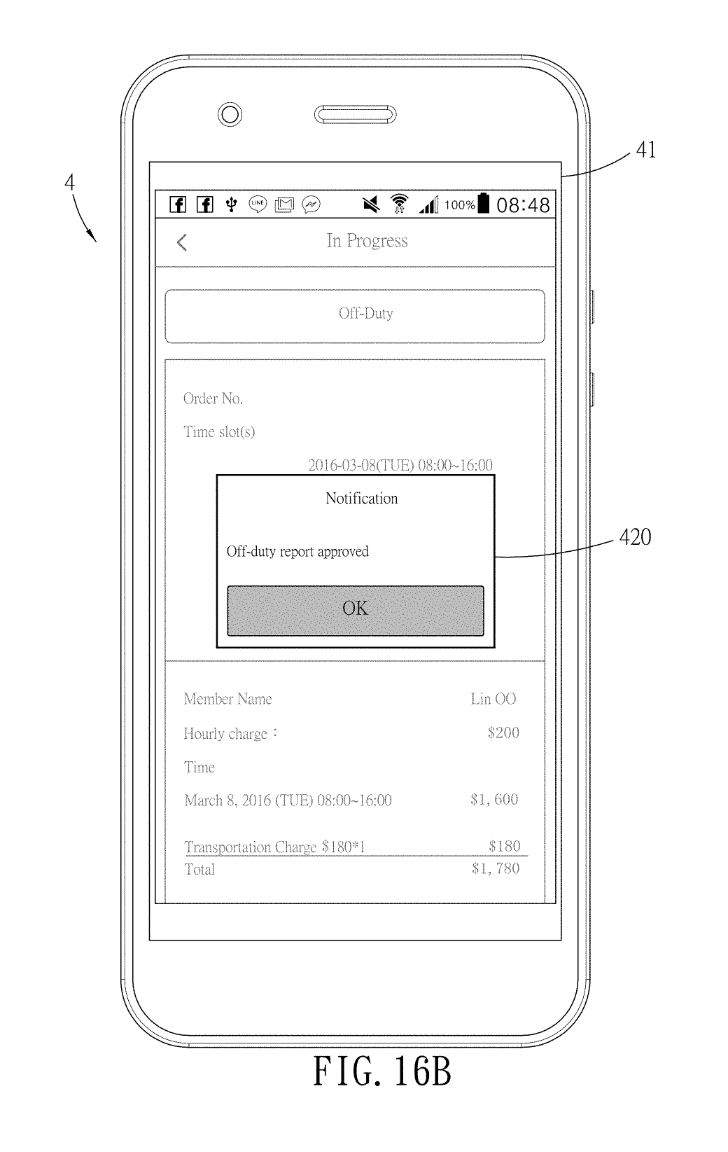

After the home care service is completed, in step S116, the service provider may operate the provider-end device 4 to create an off-duty report indicating that the service provider has completed the home care service. FIG. 16A illustrates an interface for creating the off-duty report with an off-duty button 419.

In this embodiment, the provider-end device 4 may be required to activate the positioning device when creating the off-duty report, and the created off-duty report includes position information of a current position of the provider-end device 4 generated by the positioning device, and a time stamp.

Upon receiving the off-duty report, in step S117, the processing module 11 compares the current position indicated by the position information with the required location. When the current position conforms with the required location, in step S118, the processing module 11 transmits to the provider-end device 4 a completion message 420 to notify the service provider that the off-duty report is approved (see FIG. 16B). In some embodiments, the provider-end device 4 may be required to activate the positioning device during the entire required time slot, and the processing module 11 may periodically request the position information from the provider-end device 4. By incorporating the position information and the time stamps in the on-duty report and the off-duty report, it may be easier to determine whether the service provider actually was at the required location during the required time slot.

In addition, the payment to the service providers may be implemented by remunerating each of the service providers at a predetermined frequency (e.g., twice a month) by an amount that is calculated according to a predetermined rate under an agreement between each of the service providers and the party who operates the management server 1 (e.g., a contract therebetween, U2C).

According to one embodiment of the disclosure, the management server 1 may provide a direct-message service between the user and the service provider. For example, when the user is viewing the profile of one particular service provider, he/she may be enabled to reach the service provider using the direct-message service such as Whatsapp, Line, Wechat, etc. This may enable the user and the service provider to discuss any matter regarding the assignment. In one example, the service may be available for both the user and the service provider until 30 minutes after the off-duty report is approved. A record of a conversation between the user and the service provider may be used for further evaluating the service providers or for aiding in settling potential controversies.

To sum up, the method and system as described in the disclosure provide a platform to provide home care service to users online, allowing the users to request home care service on the platform, and providing the information of the service provider(s) whose available territorial regions conforms with the required location to the users. Moreover, the payment is processed through the management server 1 which serves as a third party, thus eliminating the need to exchange cash during the home care service, ensuring a fair environment for both the user and the service provider.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for providing home care service, the method being implemented by a management server and comprising steps of:
a) obtaining profile data regarding a number of service providers who provide the home care service, and storing the profile data in a storage device of the management server, the profile data including for each of the service providers, at least a number of available territorial regions associated with the service provider;
b) receiving a request for the home care service from a client device communicating with the management server, the request including at least a required location for the home care service;
c) comparing the required location with each of the available territorial regions to determine whether any one of the available territorial regions conforms with the required location;
d) when any one of the available territorial regions conforms with the required location, outputting to the client device information of a matched one of the service providers who has the available territorial region conforming with the required location; and
e) upon receipt, from the client device, of an order for the home care service to designate the matched one of the service providers to provide the home care service, transmitting an assignment notification to a provider-end device associated with the matched one of the service providers to notify the matched one of the service providers of an assignment of the home care service.

2. The method of claim 1, wherein the profile data includes a plurality of provider profiles regarding the service providers, respectively, and each of the provider profiles includes one of a number of the available territorial regions where the service provider can provide the home care service, a charge rate for the home care service, a review score for the service provider, a number of languages that the service provider can use, an age of the service provider, work experience of the service provider, a number of time slots when the service provider is available for providing the home care service, a number of service types of the home care service that the service provider can provide, and combinations thereof;
wherein the method further comprises, between steps a) and b), a step of: transmitting interface data to the client device so as to enable the client device to display a search interface, the search interface enabling user-input of at least one requirement, the at least one requirement including one of a required charge rate, a required review score, a required language, a required age, required work experience, a required time slot, a required service type, and combinations thereof;
wherein the request for the home care service further includes the at least one requirement, and the management server further determines in step c) whether any one of the provider profiles conforms with the at least one requirement and outputs to the client device in step d) the information of the matched one of the service providers who further has the provider profile conforming with the at least one requirement.

3. The method of claim 1, wherein the profile data includes a plurality of provider profiles regarding the service providers, respectively, and each of the provider profiles includes at least a number of the available territorial regions where the service provider can provide the home care service, a charge rate for the home care service, and a number of time slots when the service provider is available for providing the home care service;
wherein the request further includes a required time slot, and the management server further determines in step c) whether any one of the provider profiles conforms with the required time period and further outputs to the client device in step d) an estimated charge that is calculated based on the charge rate of the matched one of the service providers and a length of the required time slot.

4. The method of claim 1, wherein the assignment notification transmitted to the provider-end device requires the matched one of the service providers to confirm whether to accept the assignment of the home care service.

5. The method of claim 4, further comprising, after step e), steps of:
after receiving, from the provider-end device, an assignment confirmation message indicating that the matched one of the service providers has accepted the assignment, transmitting an order notification to the client device to notify a user associated with the client device that the matched one of the service providers has accepted the assignment and to require the user to confirm a payment for the order of the home care service;
after receiving, from the client device, an order confirmation message indicating that the user has agreed to the payment for the order, communicating with a payment server for processing the payment.

6. The method of claim 1, further comprising a step of:
remunerating the matched one of the service providers at a predetermined frequency by an amount that is calculated according to a predetermined rate under an agreement between the service provider and a party that operates the management server.

7. The method of claim 1, further comprising steps of:
receiving, from the provider-end device, an off-duty report indicating that the matched one of the service providers has completed the home care service, the off-duty report including position information of a current position of the provider-end device and being generated by a positioning device of the provider-end device;
comparing the current position indicated by the position information with the required location; and
when the current position conforms with the required location, transmitting to the provider-end device a completion message to notify the matched one of the service providers that the off-duty report is approved.

8. A management server for providing home care service, said management server comprising:
a processing module;
a storage device that stores profile data regarding a number of service providers who provide the home care service, the profile data including, for each of the service providers, at least a number of available territorial regions associated with the service provider; and
a communicating module configured to communicate with a client device, and a plurality provider-end devices that are associated with the service providers, respectively,
wherein said processing module is programmed to:
receive a request for the home care service from the client device, the request including at least a required location for the home care service;
compare the required location with each of the available territorial regions to determine whether any one of the available territorial regions conforms with the required location;
when any one of the available territorial regions conforms with the required location, output to the client device information of a matched one of the service providers who has the available territorial region conforming with the required location; and
upon receipt, from the client device, of an order for the home care service to designate the matched one of the service providers to provide the home care service, transmit an assignment notification to one of the provider-end devices that is associated with the matched one of the service providers to notify the matched one of the service providers of an assignment of the home care service.

9. The management server of claim 8, wherein the profile data includes a plurality of provider profiles regarding the service providers, respectively, and each of the provider profiles includes one of a number of the available territorial regions where the service provider can provide the home care service, a charge rate for the home care service, a review score for the service provider, a number of languages that the service provider can use, an age of the service provider, work experience of the service provider, a number of time slots when the service provider is available for providing the home care service, a number of service type of the home care service that the service provider can provide, and combinations thereof;
wherein said processing module is further programmed to, prior to receiving the request, transmit interface data to the client device so as to enable the client device to display a search interface, the search interface enabling user-input of at least one requirement, the at least one requirement including one of a required charge rate, a required review score, a required language, a required age, required work experience, a required time slot, a required service type, and combinations thereof;
wherein the request for the home care service further includes the at least one requirement, and said processing module is further programmed to determine whether any one of the provider profiles conforms with the at least one requirement and to output to the client device the information of the matched one of the service providers who further has the provider profile conforming with the at least one requirement.

10. The management server of claim 8, wherein the profile data includes a plurality of provider profiles regarding the service providers, respectively, and each of the provider profiles includes at least a number of the available territorial regions where the service provider can provide the home care service, a charge rate for the home care service, and a number of time slots when the service provider is available for providing the home care service;
wherein the request further includes a required time slot, and said processing module is further programmed to determine whether any one of the provider profiles conforms with the required time period, and to further output to the client device an estimated charge that is calculated based on the charge rate of the matched one of the service providers and a length of the required time slot.

11. The management server of claim 8, wherein the assignment notification transmitted to the provider-end device requires the matched one of the service providers to confirm whether to accept the assignment of the home care service.

12. The management server of claim 11, wherein said processing module is further programmed to, after transmitting the assignment notification:
after receiving from the provider-end device an assignment confirmation message indicating that the matched one of the service providers has accepted the assignment, transmit an order notification to the client device to notify a user associated with the client device that the matched one of the service providers has accepted the assignment and to require the user to confirm a payment for the order of the home care service;
after receiving from the client device an order confirmation message indicating that the user has agreed to the payment for the order, communicate with a payment server for processing the payment through said communicating module.

13. The management server of claim 8, wherein said processing module is further programmed to calculate an amount for remunerating the matched one of the service providers at a predetermined frequency according to a predetermined rate under an agreement between the service provider and a party that operates said management server.

14. The management server of claim 8, wherein said processing module is further programmed to:
receive, from the provider-end device, an off-duty report indicating that the matched one of the service providers has completed the home care service, the off-duty report including position information of a current position of the provider-end device and being generated by a positioning device of the provider-end device;
compare the current position indicated by the position information with the required location; and
when the current position conforms with the required location, transmit to the provider-end device a completion message to notify the matched one of the service providers that the off-duty report is approved.
